(19) United States
(12) Patent Application Publication
(10) Pub. No.: US 2008/0178177 A1
(43) Pub. Date: Jul. 24, 2008

(54) Method and Apparatus for Operating a Massively Parallel Computer System to Utilize Idle Processor Capability at Process Synchronization Points

(76) Inventors: Charles Jens Archer, Rochester, MN (US); Roy Glenn Musselman, Rochester, MN (US); Amanda Peters, Rochester, MN (US); Kurt Walter Pinnow, Rochester, MN (US); Brent Allen Swartz, Chippewa Falls, WI (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/624,942

(22) Filed: Jan. 19, 2007

(51) Int. Cl. G06F 9/46

(52) U.S. Cl. 718/100

(57) ABSTRACT

Individual components of a parallel system perform system maintenance operations during the times that the components are idle waiting for synchronization with other components. When all applicable components reach synchronization, further performance of system maintenance is suspended until the component is again idle at another synchronization point. Preferably, the component is a node having at least one processor and a nodal memory in a multi-node system. A system maintenance operation is preferably an interruptible and resumable diagnostic, such as a memory check. Although the amount of time allotted to system maintenance varies by component, over many synchronization points the total times in each node are sufficient for the maintenance operation.

### STATEMENT REGARDING FEDERALLY SPONSORED RESEARCH OR DEVELOPMENT

This invention was made with Government support under Contract No. B519700 awarded by the Department of Energy. The Government has certain rights in this invention.

### FIELD OF THE INVENTION

The present invention relates to digital data processing, and in particular to the operation of massively parallel computer systems comprising multiple nodes executing parallel processes.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises one or more central processing units (CPU) and supporting hardware necessary to store, retrieve and transfer information, such as communication buses and memory. It also includes hardware necessary to communicate with the outside world, such as input/output controllers or storage controllers, and devices attached thereto such as keyboards, monitors, tape drives, disk drives, communication lines coupled to a network, etc. The CPU or CPUs are the heart of the system. They execute the instructions which comprise a computer program and direct the operation of the other system components.

From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Sophisticated software at multiple levels directs a computer to perform massive numbers of these simple operations, enabling the computer to perform complex tasks. What is perceived by the user as a new or improved capability of a computer system is made possible by performing essentially the same set of very simple operations, but doing it much faster, and thereby enabling the use of software having enhanced function. Therefore continuing improvements to computer systems require that these systems be made ever faster.

The overall speed of a computer system (also called the throughput) may be crudely measured as the number of operations performed per unit of time. Conceptually, the simplest of all possible improvements to system speed is to increase the clock speeds of the various components, and particularly the clock speed of the processor(s). E.g., if everything runs twice as fast but otherwise works in exactly the same manner, the system will perform a given task in half the time. Enormous improvements in clock speed have been made possible by reduction in component size and integrated circuitry, to the point where an entire processor, and in some cases multiple processors along with auxiliary structures such as cache memories, can be implemented on a single integrated circuit chip. Despite these improvements in speed, the demand for ever faster computer systems has continued, a demand which can not be met solely by further reduction in component size and consequent increases in clock speed. Attention has therefore been directed to other approaches for further improvements in throughput of the computer system.

Without changing the clock speed, it is possible to improve system throughput by using multiple processors. The modest cost of individual processors packaged on integrated circuit chips has made this approach practical. Although the use of multiple processors creates additional complexity by introducing numerous architectural issues involving data coherency, conflicts for scarce resources, and so forth, it does provide the extra processing power needed to increase system throughput.

Various types of multi-processor systems exist, but one such type of system is a massively parallel nodal system for computationally intensive applications. Such a system typically contains a large number of processing nodes, each node having its own processor or processors and local (nodal) memory, where the nodes are arranged in a regular matrix or lattice structure for inter-nodal communication. The inter-nodal communications lattice allows different sub-processes of an application executing in parallel on different nodes to exchange data with one another. Typically, such a system further contains a control mechanism for controlling the operation of the nodes, and an I/O mechanism for loading data into the nodes from one or more I/O devices and receiving output from the nodes to the I/O device(s). In general, each node acts as an independent computer system in that the addressable memory used by the processor is contained entirely within the processor's local node, and the processor has no capability to directly reference data addresses in other nodes. However, the control mechanism and I/O mechanism are shared by all the nodes.

A massively parallel nodal system such as described above is a general-purpose computer system in the sense that it is capable of executing general-purpose applications, but it is designed for optimum efficiency when executing parallel, computationally intensive applications. In such an application environment, each of multiple sub-processes or threads of a process are executed in different respective nodes, and pass data to one another at pre-defined points in the progress of the program. Because each node is executing its sub-process more or less independently, there is often a need to synchronize the progress of the various sub-processes, so that data will be transferred among nodes in a coherent fashion for the application. A massively parallel nodal system will typically have some form of synchronization mechanism, whereby processes may be required to wait at defined progress points (synchronization points) until all processes of a group have reached the required stage of progress.

An exemplary massively parallel nodal system is the IBM Blue Gene™ system. The IBM Blue Gene system contains many processing nodes, each having multiple processors and a common local (nodal) memory. The processing nodes are arranged in a logical three-dimensional torus network having point-to-point data communication links between each node and its immediate neighbors in the network. Additionally, each node can be configured to operate either as a single node or multiple virtual nodes (one for each processor within the node), thus providing a fourth dimension of the logical network. A large processing application typically creates one ore more blocks of nodes, herein referred to as communicator sets, for performing specific sub-tasks during execution. The application may have an arbitrary number of such communicator sets, which may be created or dissolved at multiple points during application execution. A communications network called a “barrier network”, which is separate from the torus network used to communicate process data, provides a synchronization mechanism whereby a group of nodes can be held at a synchronization point until all nodes of the group are ready to proceed, and thus to synchronize applications executed on the system. There are other forms of synchronization supported by the Blue Gene system as well.

Where it is necessary to synchronize sub-processes executing on different nodes, it is desirable to allocate the workload to each node as evenly as possible so that the sub-processes will reach the synchronization point at approximately the same time. However, there are far too many parameters affecting the execution times of the sub-processes to assure that this will always be the case. Often, many nodes are idle while waiting for one or more other nodes to reach the synchronization point.

The complexity of a massively parallel system such as the Blue Gene system makes system maintenance a challenge, requiring supportive maintenance mechanisms commensurate with the complexity of the system. The sheer number of individual nodes, processors, memories and inter-nodal connections and interfaces increases the probability that some component of the system will malfunction. It is not practicable to operate a system of such complexity without some capability to detect, diagnose and correct/circumvent a malfunction of some component. Accordingly, a variety of internal maintenance mechanisms have been designed into the Blue Gene system. These maintenance mechanisms can not only be used to identify a component which has malfunctioned, but in some cases to identify components operating near the limits of acceptable performance specifications, or otherwise likely to fail in the near future. In many cases, self-healing maintenance mechanisms are available to by-pass a failing component, substitute another component, or in some other way to alleviate, correct or circumvent the effects of a component malfunction.

Although various maintenance mechanisms are available, these mechanisms themselves impose an overhead burden on system operations. For example, diagnostic software may be executed to perform certain simple exercises with memory, registers, I/O drivers, and so forth, but execution of the diagnostics themselves take considerable time, during which the system is not being used for productive work.

A need exists for continuing improvements to system maintenance mechanisms, to support increased complexity of massively parallel systems, and in particular, for system maintenance mechanisms which reduce the overhead burden of their operation.

### SUMMARY OF THE INVENTION

Individual components of a massively parallel system are configured to perform system maintenance operations during the times that the components are idle as a result of the need to synchronize software sub-processes executing in different system components. When all applicable components reach the synchronization point, further performance of the system maintenance operation is suspended until the component is again idle at another synchronization point.

In the preferred embodiment, the component is a node having at least one processor and a nodal memory. Each node of a group of nodes (which may be all nodes of the system, but is more typically some subset of the nodes) executes a respective sub-process of an application being executed by the massively parallel system, the application having one or more synchronization points. Each sub-process, upon reaching a synchronization point, idles until the last sub-process has reached the synchronization point. During this period that the sub-process is waiting at the synchronization point, the node's processor(s) execute one or more system diagnostic routines. Preferably, the diagnostic routine is both interruptible and restartable, i.e., the diagnostic routine has the property that it can be interrupted at any time, and that its state at the time of interruption can be saved so that it can later be resumed at the point where it left off. An example of such a system diagnostic routine is a memory check which tests each memory cell of a nodal memory in turn to verify that the memory cell is functioning properly, it being understood that other diagnostic routines or other forms of maintenance operations could alternatively be performed.

Each node performs diagnostics independently, and within each node the state of the diagnostic process or processes is saved, and can be resumed at a later synchronization point. Although it is true that, at any given synchronization point, the time available for performing diagnostics is not guaranteed, and at least one node (i.e., the last node to reach the synchronization point) will not perform any diagnostics, over time it is expected that idle processor cycles at synchronization points will be distributed more or less randomly. Therefore, as long as it is possible to resume diagnostic processes where they are left off, it should be possible to perform diagnostics in all of the nodes by executing diagnostics during otherwise idle cycles at synchronization points.

By performing diagnostics or other maintenance operations independently in each node during idle periods at process synchronization points in accordance with the preferred embodiment, it is possible to execute time-consuming diagnostics with a minimal amount of performance overhead. Thus, without interrupting productive work on the system, useful diagnostic or similar information can be obtained, and corrective actions can be taken.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major components of a massively parallel computer system, in accordance with the preferred embodiment of the present invention.

FIG. 2 is a simplified representation of a three dimensional lattice structure and inter-nodal communication network of the system of FIG. 1, according to the preferred embodiment.

FIG. 3 is a simplified representation of a single subset of compute nodes and associated I/O node connected by a local I/O tree network, according to the preferred embodiment.

FIG. 4 is a simplified representation of a collective network for certain broadcast and reduction operations, according to the preferred embodiment.

FIG. 5 is a high-level block diagram showing the major hardware components of a node within a compute core according to the preferred embodiment.

FIGS. 6A and 6B are high-level block diagrams of the major software components of memory in a compute node configured in different operating modes, in accordance with the preferred embodiment.

FIG. 7 is a high level flow diagram of the actions taken within a single compute node to execute a sub-process of an application and perform diagnostic functions while idling at synchronization points, according to the preferred embodiment.

FIG. 8 is a timeline illustrating of how each of multiple nodes is able to perform a diagnostic function at different synchronization points without significantly delaying progress of an application, according to the preferred embodiment.

### DETAILED DESCRIPTION OF THE PREFERRED EMBODIMENT

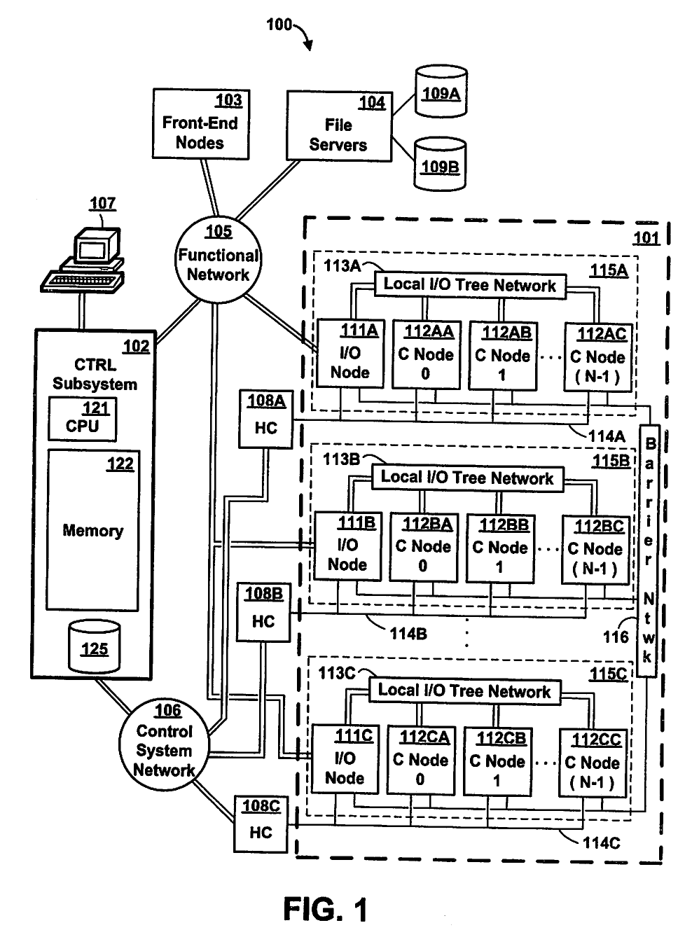

Referring to the Drawing, wherein like numbers denote like parts throughout the several views, FIG. 1 is a high-level block diagram of the major hardware components of a massively parallel computer system 100 in accordance with the preferred embodiment of the present invention. In the preferred embodiment, computer system 100 is an IBM Blue Gene™ computer system, it being understood that other computer systems could be used, and the description of a preferred embodiment herein is not intended to limit the present invention to the particular architecture described. Additional background information concerning the architecture of an IBM Blue Gene™ computer system can be found in the following commonly owned, copending U.S. patent applications and PCT application designating the United States, each of which are herein incorporated by reference:

U.S. patent application Ser. No. 10/468,991, filed Feb. 25, 2002, entitled “Arithmetic Functions in Torus and Tree Network”;

U.S. patent application Ser. No. 10/469,000, filed Feb. 25, 2002, entitled “Global Tree Network for Computing Structure”;

U.S. patent application Ser. No. 10/468,993, filed Feb. 25, 2002, entitled “Novel Massively Parallel Supercomputer”;

U.S. patent application Ser. No. 10/468,996, filed Feb. 25, 2002, entitled “Fault Isolation Through No-Overhead Link Level CRC”;

U.S. patent application Ser. No. 10/468,997, filed Feb. 25, 2002, entitled “Global Interrupt and Barrier Networks”;

PCT patent application US 2005/025616, filed Jul. 19, 2004, entitled “Collective Network for Computer Structures”, published as WO 2006/020298 A2;

U.S. patent application Ser. No. 11/279,620, filed Apr. 13, 2006, entitled “Executing an Allgather Operation on a Parallel Computer”;

U.S. patent application Ser. No. 11/539,248, filed Oct. 6, 2006, entitled “Method and Apparatus for Routing Data in an Inter-Nodal Communications Lattice of a Massively Parallel Computer System by Dynamic Global Mapping of Contended Links”;

U.S. patent application Ser. No. 11/539,270, filed Oct. 6, 2006, entitled “Method and Apparatus for Routing Data in an Inter-Nodal Communications Lattice of a Massively Parallel Computer System by Semi-Randomly Varying Routing Policies for Different Packets”;

U.S. patent application Ser. No. 11/539,300, filed Oct. 6, 2006, entitled “Method and Apparatus for Routing Data in an Inter-Nodal Communications Lattice of a Massively Parallel Computer System by Routing Through Transporter Nodes”; and

U.S. patent application Ser. No. 11/539,329, filed Oct. 6, 2006, entitled “Method and Apparatus for Routing Data in an Inter-Nodal Communications Lattice of a Massively Parallel Computer System by Dynamically Adjusting Local Routing Strategies”.

Computer system 100 comprises a compute core 101 having a large number of compute nodes logically arranged for inter-nodal communication in a regular array or lattice, which collectively perform the bulk of the useful work performed by system 100. The operation of computer system 100 including compute core 101 is generally controlled by control subsystem 102. Various additional processors contained in front-end nodes 103 perform certain auxiliary data processing functions, and file servers 104 provide an interface to data storage devices such as rotating magnetic disk drives 109A, 109B or other I/O (not shown). Functional network 105 provides the primary data communications path among the compute core 101 and other system components. For example, data stored in storage devices attached to file servers 104 is loaded and stored to other system components through functional network 105.

Compute core 101 comprises I/O nodes 111A-C (herein generically referred to as feature 111) and compute nodes 112AA-AC, 112BA-BC, 112CA-CC (herein generically referred to as feature 112). Compute nodes 112 are the workhorse of the massively parallel system 100, and are intended for executing compute-intensive applications which may require a large number of processes proceeding in parallel. I/O nodes 111 handle I/O operations on behalf of the compute nodes. Each I/O node contains an I/O processor and I/O interface hardware for handling I/O operations for a respective set of N compute nodes 112, the I/O node and its respective set of N compute nodes being referred to as a Pset. Compute core 101 contains M Psets 115A-C (herein generically referred to as feature 115), each containing a single I/O node III and N compute nodes 112, for a total of M×N compute nodes 112. The product M×N can be very large. For example, in one implementation M=1024 (1K) and N=64, for a total of 64K compute nodes.

In general, application programming code and other data input required by the compute core for executing user application processes, as well as data output produced by the compute core as a result of executing user application processes, is communicated externally of the compute core over functional network 105. The compute nodes within a Pset 115 communicate with the corresponding I/O node over a corresponding local I/O tree network 113A-C (herein generically referred to as feature 113), which is described in greater detail herein. The I/O nodes in turn are attached to functional network 105, over which they communicate with I/O devices attached to file servers 104, or with other system components. Functional network 105 thus handles all the I/O for the compute nodes, and requires a very large bandwidth. Functional network 105 is, in the preferred embodiment, a set of gigabit Ethernet interfaces to multiple Ethernet switches. The local I/O tree networks 113 may be viewed logically as extensions of functional network 105, since I/O operations proceed through both networks, although they are physically separated from functional network 105 and observe different protocols.

Control subsystem 102 directs the operation of the compute nodes 112 in compute core 101. Control subsystem 102 is preferably a mini-computer system including its own processor or processors 121 (of which one is shown in FIG. 1), internal memory 122, and local storage 125, and having an attached console 107 for interfacing with a system administrator or similar person. Control subsystem 102 includes an internal database which maintains certain state information for the compute nodes in core 101, and various control and/or maintenance applications which execute on the control subsystem's processor(s) 121, and which control the allocation of hardware in compute core 101, direct the pre-loading of data to the compute nodes, and perform certain diagnostic and maintenance functions. Control system communicates control and state information with the nodes of compute core 101 over control system network 106. Network 106 is coupled to a set of hardware controllers 108A-C (herein generically referred to as feature 108). Each hardware controller communicates with the nodes of a respective Pset 115 over a corresponding local hardware control network 114A-C (herein generically referred to as feature 114). The hardware controllers 108 and local hardware control networks 114 may be considered logically as extensions of control system network 106, although they are physically separate. The control system network and local hardware control network operate at significantly lower data rates than the functional network 105.

In addition to control subsystem 102, front-end nodes 103 comprise a collection of processors and memories which perform certain auxiliary functions which, for reasons of efficiency or otherwise, are best performed outside the compute core. Functions which involve substantial I/O operations are generally performed in the front-end nodes. For example, interactive data input, application code editing, or other user interface functions are generally handled by front-end nodes 103, as is application code compilation. Front-end nodes 103 are coupled to functional network 105 for communication with file servers 104, and may include or be coupled to interactive workstations (not shown).

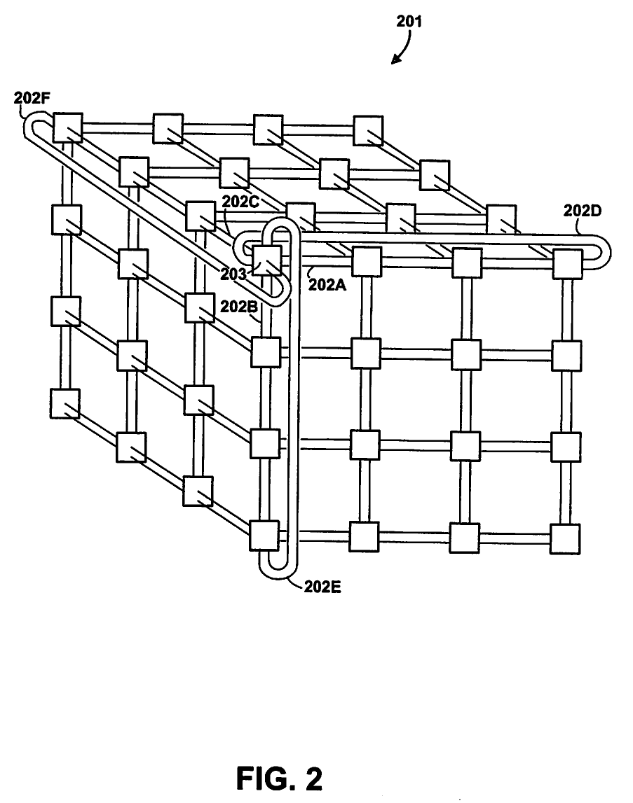

Compute nodes 112 are logically arranged for inter-nodal communication in a three dimensional lattice, each compute node having a respective x, y and z coordinate. FIG. 2 is a simplified representation of the three dimensional lattice structure 201, according to the preferred embodiment. Referring to FIG. 2, a simplified 4×4×4 lattice is shown, in which the interior nodes of the lattice are omitted for clarity of illustration. Although a 4×4×4 lattice (having 64 nodes) is represented in the simplified illustration of FIG. 2, it will be understood that the actual number of compute nodes in the lattice is typically much larger. Each compute node in lattice 201 contains a set of six bidirectional node-to-node communication links 202A-F (herein referred to generically as feature 202) for communicating data with its six immediate neighbors in the x, y and z coordinate dimensions. Each link is referred to herein as “bidirectional” in the logical sense since data can be sent in either direction; it is physically constructed as a pair of unidirectional links.

As used herein, the term “lattice” includes any regular pattern of nodes and inter-nodal data communications paths in more than one dimension, such that each node has a respective defined set of neighbors, and such that, for any given node, it is possible to algorithmically determine the set of neighbors of the given node from the known lattice structure and the location of the given node in the lattice. A “neighbor” of a given node is any node which is linked to the given node by a direct inter-nodal data communications path, i.e. a path which does not have to traverse another node. A “lattice” may be three-dimensional, as shown in FIG. 2, or may have more or fewer dimensions. The lattice structure is a logical one, based on inter-nodal communications paths. Obviously, in the physical world, it is impossible to create physical structures having more than three dimensions, but inter-nodal communications paths can be created in an arbitrary number of dimensions. It is not necessarily true that a given node's neighbors are physically the closest nodes to the given node, although it is generally desirable to arrange the nodes in such a manner, insofar as possible, as to provide physical proximity of neighbors.

In the preferred embodiment, the node lattice logically wraps to form a torus in all three coordinate directions, and thus has no boundary nodes. E.g., if the node lattice contains dimx nodes in the x-coordinate dimension ranging from 0 to (dimx−1), then the neighbors of Node((dimx−1), y0, z0) include Node((dimx−2), y0, z0) and Node (0, y0, z0), and similarly for the y-coordinate and z-coordinate dimensions. This is represented in FIG. 2 by links 202D, 202E, 202F which wrap around from a last node in an x, y and z dimension, respectively to a first, so that node 203, although it appears to be at a “corner” of the lattice, has six node-to-node links 202A-F. It will be understood that, although this arrangement is a preferred embodiment, a logical torus without boundary nodes is not necessarily a requirement of a lattice structure.

The aggregation of node-to-node communication links 202 is referred to herein as the torus network. The torus network permits each compute node to communicate results of data processing tasks to neighboring nodes for further processing in certain applications which successively process data in different nodes. However, it will be observed that the torus network contains only a limited number of links, and data flow is optimally supported when running generally parallel to the x, y or z coordinate dimensions, and when running to successive neighboring nodes. Preferably, applications take advantage of the lattice structure by subdividing computation tasks so that much of the data flows to neighboring nodes and along logical paths of the lattice. A routing mechanism determines how to route data packets through successive nodes and links of the lattice.

The torus network provides general node-to-node data exchange for application state data generated as a result of executing an application on multiple nodes in parallel. In addition to the torus network, an I/O tree network and a collective network, both of which are separate from and independent of the torus network, are used for communicating certain data. The I/O tree network is used for I/O communications, i.e., for transferring data between a node and an I/O device. The collective network is used for certain reduction operations, i.e., operations in which some mathematical function is generated with respect to data collected from all nodes, and for broadcast of data to all nodes. The I/O tree network and collective network share certain hardware, although they are logically independent networks. The torus network is both logically and physically independent of the I/O tree network and collective network. I.e., the torus network does not share physical links with the other networks, nor is the torus network lattice logically dependent on the arrangement of the other networks.

In addition to the torus network, I/O tree network and collective network, an independent barrier network 116 provides certain synchronization and interrupt capabilities. The barrier network contains four independent channels, each channel being logically a global OR over all nodes. Physically, individual node outputs on each channel are combined in hardware and propagate to the top of a combining tree; the resultant signal is then broadcast down the tree to the nodes. A global AND can be achieved by using inverted logic. Generally, the global AND is used as a synchronization barrier to force multiple sub-processes of a common application executing in different nodes to synchronize at some pre-defined point of progress. The global OR is generally used as an interrupt.

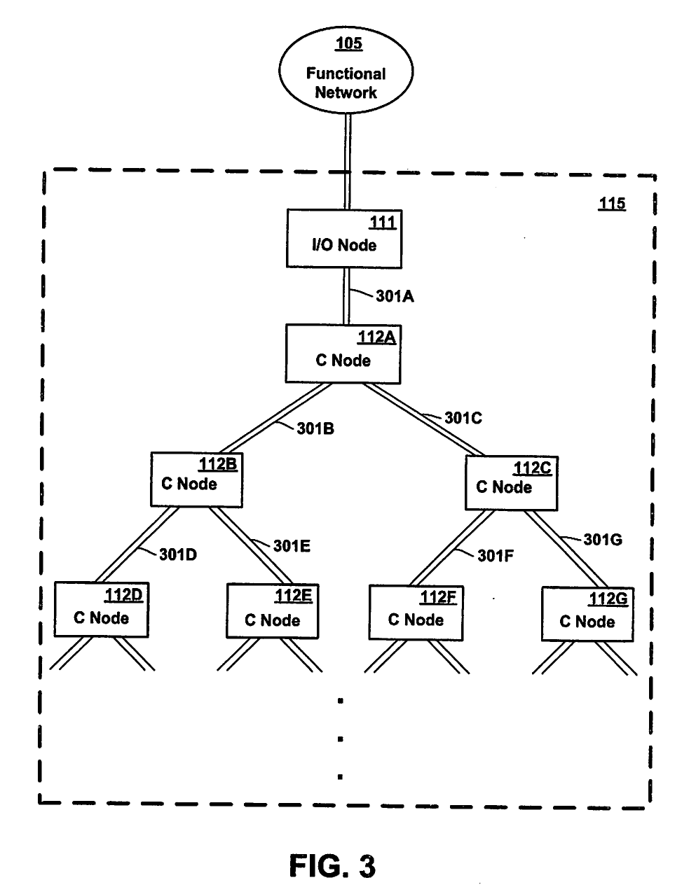

FIG. 3 is a simplified representation of a single Pset 115 and its associated local I/O tree network 113, according to the preferred embodiment. Each Pset 115 contains a single I/O node 111, which communicates with functional network 105 using a gigabit Ethernet interface. The compute nodes 112A-G of the Pset are arranged in a binary tree of bidirectional node-to-node communication links 301A-G (herein referred to generically as feature 301). I.e., a binary tree is a tree having a single root node, in which every node has one and only one parent (except the root node, which has no parent), and in which every node has 0, 1 or 2 children. Inbound I/O communications (i.e., those coming from an external device to a compute node) arrive over functional network 105 in I/O node 111, and are transmitted downward on local I/O tree 113 through successive links 301 and intermediate nodes until the destination is reached. Outbound I/O communications are transmitted up the tree 113 to I/O node 111, and thence on the functional network 105.

A separate I/O tree network 113 as represented in FIG. 3 exists for each Pset 115, and each corresponding I/O node 111 has a direct connection with functional network 105. I/O node 111 has one and only one child, which is compute node 112A. Although the representation of FIG. 3 shows two children for every compute node, it will be recognized that some compute nodes may have only one child or have no children.

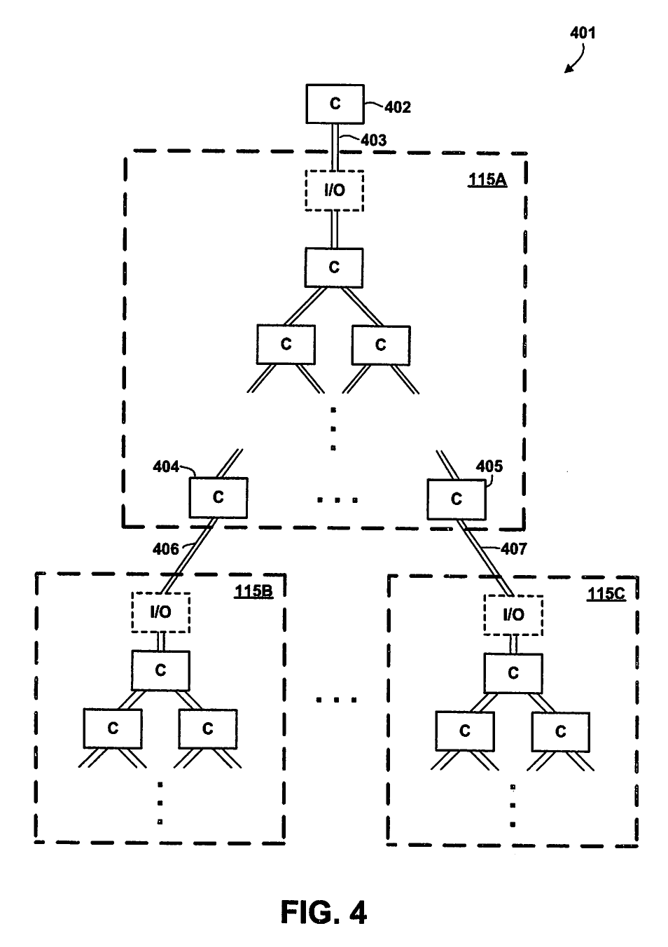

FIG. 4 is a simplified representation of collective network 401, according to the preferred embodiment. Collective network 401 encompasses all the compute nodes 112 in compute core 101. Collective network 401 is logically a single binary tree, having a single compute node 402 at its root.

Physically, the collective network is constructed as a conglomeration of the various local I/O tree networks, which are themselves arranged in a tree. One local I/O network, corresponding to Pset 115A, is at the root of the tree. The I/O node within this network is a child node of root node 402, and communicates directly with root node 402 through bidirectional link 403, which is physically the same as all other links of the local I/O tree network. Root node 402 could alternatively be a compute node in Pset 115A. Additional local I/O tree networks (corresponding to Pset 115B, 115C) are coupled to the root I/O tree network. I.e., each respective I/O node within Pset 115B, 115C is coupled as a child node to respective compute node 404, 405 as parent in Pset 115A via respective bidirectional links 406, 407 (which are physically the same as all other links of the local I/O tree network). Compute nodes 406, 407 are generally leaf nodes of Pset 115A.

In operation, the I/O nodes serve only as conduits for the collective network. Since both the local I/O tree networks 113 and the collective network 401 share the same hardware, each data packet being transmitted on either network contains a field specifying the mode of transmission, i.e., specifying the logical network on which the data packet is being transmitted. If the collective network is specified, the I/O node simply passes the data packet up or down the tree, as the case may be, without further examining it. If the local I/O tree network is specified, the I/O node transmits an outbound data packet on functional network 105. Compute nodes 402, 404, 405 selectively route data in an analogous manner. Thus, although the I/O nodes are physically linked to the collective network, they are not a logical part of the collective network. For this reason they are represented as dashed lines in FIG. 4.

The purpose of the collective network is to support certain reduction and broadcast operations, which necessarily involve all of the compute nodes. Specifically, certain simple mathematical reduction operations can be performed on data gathered from all of the compute nodes to produce composite data. Such data is passed up through the collective network, and at each successive node, data is combined according to the applicable mathematical function be performed to produce resultant composite data for the node and all its children in the collective network. When the data reaches the root node, the resultant composite data at the root node represents the function across all of the compute nodes. Similarly, data can be broadcast to all of the nodes by beginning at the root and, at each successive node, re-transmitting the data to that node's children.

Although the collective network contains physical connections whereby it is possible to communicate data between any arbitrary pair of nodes, it is not efficiently designed for that purpose, nor is it used for that purpose. Node-to-node communication would inevitably burden some nodes (especially the root node) disproportionately. It is the torus network which is designed to support node-to-node communication.

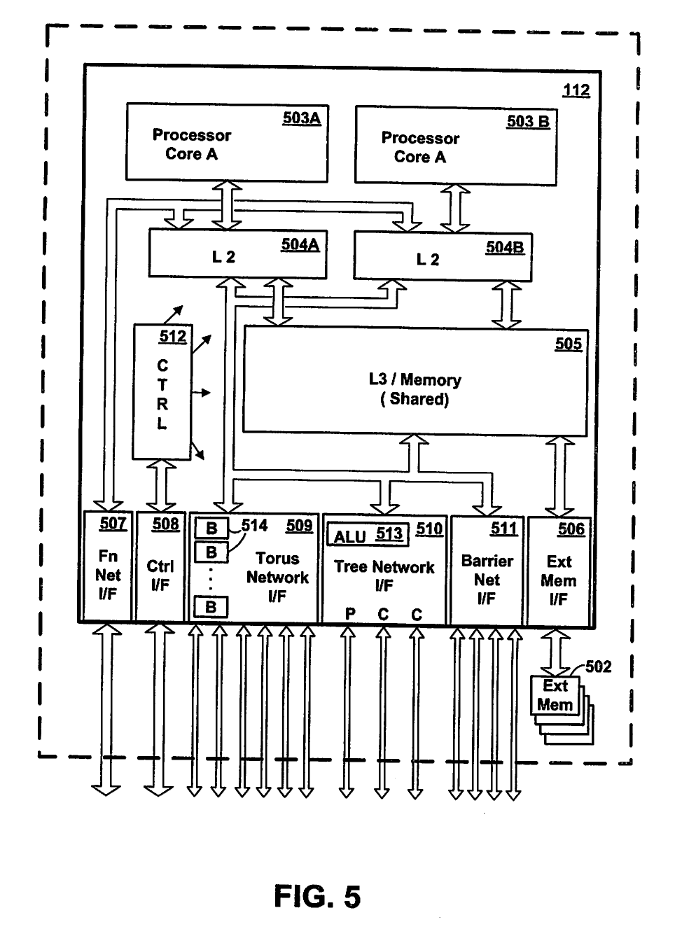

FIG. 5 is a high-level block diagram showing the major hardware components of a node within compute core 101, and in particular shows the major components of a parallel processor application specific integrated circuit (ASIC) chip 501 which forms the heart of the node, according to the preferred embodiment. The node represented in FIG. 5 could be either an I/O node 111 or a compute node 112, although not all interface connections are present in each node type. Each node in compute core 101, whether an I/O node 111 or a compute node 112, contains a single parallel processor ASIC chip 501, the same physical chip design being used for either type node. The node may also contain a number of memory chips 502 external to ASIC 501.

Parallel processor ASIC 501 contains a pair of processor cores 503A, 503B (herein referred to generically as feature 503). From a hardware standpoint, each processor core 503 is an independent processing entity capable of maintaining state for and executing threads independently (although it does not always operate in this mode, as explained below). Specifically, each processor core 503 contains its own instruction state register or instruction address register which records a current instruction being executed, instruction sequencing logic, instruction decode logic, arithmetic logic unit or units, data registers, and various other components required for maintaining thread state and executing a thread, including a floating point unit, level 1 instruction cache and level 1 data cache (not shown). Each processor core is coupled to a respective level 2 (L2) cache 504A, 504B (herein referred to generically as feature 504), which is in turn coupled to a common L3 cache and on-chip memory 505. The internal chip L3 cache/memory 505 communicates through external memory interface 506 to one or more external memory chips 502 in the same node. ASIC 501 and any external memory chips are preferably packaged on a common printed circuit board assembly (not shown).

In addition to external memory interface 506, which does not communicate outside the node in which ASIC 501 resides, parallel processor ASIC 501 contains five separate external data communications interfaces, all of which communicate externally of the node. These interfaces are: functional network interface 507, control network interface 508, torus network interface 509, tree network interface 510, and barrier network interface 511.

Functional network interface 507 is used for communicating through functional network 105, i.e. is in the preferred embodiment a gigabit Ethernet interface. It is coupled directly with the L2 caches 504 via its own chip-internal bus, a design which allows data to be rapidly transferred to or from another network through the L2.caches, and to be manipulated by a processor core 503. The functional network interface hardware is present in all ASICs 501, but it is only used in the I/O nodes 111. In compute nodes 112, the functional network interface is not used, and is not coupled to anything external of the chip.

Control interface 508 is used for communicating with control system network 106 through the hardware controller 108 for the Pset 115 in which the node resides. This network is used primary for system initialization, maintenance, diagnostics, and so forth. As such, it generally does not require large data capacity, and in the preferred embodiment is an IEEE 1149.1 JTAG interface. Control interface 508 is internally coupled to monitoring and control logic 512, which is represented for simplicity as a single entity, although it may be implemented in multiple modules and locations. Monitoring and control logic can access certain registers in processor cores 503 and locations in nodal memory on behalf of control subsystem 102 to read or alter the state of the node, perform diagnostic scanning, and so forth.

Torus network interface 509 provides connections to the six logical node-to-node bidirectional links 202 connecting the node to the torus network. In reality, each link 202 is implemented as a pair of unidirectional links, so torus network interface actually contains twelve ports, six for incoming data and six for outgoing data. In the case of an I/O node 111, torus network interface 509 is not used.

Torus network interface 509 can be used to transmit a data packet originating in the node in which the interface resides to an immediate neighboring node, but much of the traffic handled by the torus network interface is pass-through traffic, i.e., consists of data packets originating in other nodes and destined for other nodes, which pass through the node of the interface on their way to their ultimate destination. The torus network interface includes a set of six outbound data buffers 514, one buffer corresponding to each of the six node-to-node links 202. An incoming data packet to be passed through to another node is placed in one of the outbound data buffers 514 for retransmission, without reading the data into internal chip memory 505 or cache 502. Torus network interface 509 includes routing logic for selecting an appropriate outbound data buffer 514 for retransmission, in accordance with an applicable routing policy. Thus pass-through data packets impose a minimal burden on the hardware resources of the node (outside the torus network interface). Outbound data originating in the node of the interface is also placed in an appropriate outbound data buffer for transmission. In this case, a software router function executing in the node's processor will determine a routing policy for the outbound data.

Tree network interface 510 provides connection to the node-to-node bidirectional links of the local I/O tree network 115 and the collective network 401. As explained above, these two networks share the same physical node-to-node links. Each tree network interface contains a single link interface to a parent, and a pair of interfaces to children of the node. As in the case of the torus network, each of the logical bidirectional links is implemented as a pair of unidirectional links, so the tree network interface actually contains six ports, two for the parent and four for the two children. Both the I/O nodes 111 and the compute nodes 112 use the tree network interface, but it is not necessarily true that all ports in the interface are connected. Some of the nodes will have no children or only one child, and the single root node 402 of the collective network will have no parent.

Tree network interface 510 includes or is closely coupled to a dedicated arithmetic logic unit (ALU) 513 for performing certain mathematical reductions of data being gathered up the tree. ALU 513 performs a limited set of simple integer arithmetic and logical operations on data. For example, ALU 513 may perform such operations as integer addition, integer maximum, bitwise logical AND, OR and XOR, etc. In general, the operands of operations performed by ALU 513 are obtained from the child nodes of the node performing the operation, and from the node itself, and the result is then forwarded to the parent of the node performing the operation. For example, suppose it is desired to find a sum of a respective nodal state value from each compute node in the compute core 111. Beginning with the leaf nodes, each node adds the state values, if any, received from its children to its own state value, and transmits the result to its parent. When a data packet containing a partial sum reaches an I/O node, the I/O node simply forwards it on to the next node of the collective network, without changing any of the data. When the resultant data packet reaches the root node and the state value sum contained therein is added to the root node's value, the resulting sum is the sum of all state values from the compute nodes. Similar operations can be performed using other mathematical functions in ALU 513. By providing a dedicated ALU in the tree network interface, global reduction operations can be performed very efficiently, with minimal interference to processes executing in processor cores 503. A data packet representing partial reduction data arrives in the tree network interface from a child, provides operands for ALU 513, and a successor packet with resultant data is forwarded up the tree to the node's parent from tree network interface, without the data ever having to enter the node's memory 505, 502 or cache 502.

Barrier network interface 511 provides an interface to barrier network 116, and provides global interrupt and barrier capability to the compute nodes. The barrier network can be used as a “barrier” for process synchronization, which prevents a set of nodes from proceeding past a certain execution stop point until all nodes have reached the stop point as indicated by the signals on the barrier. It can also be used as a global interrupt.

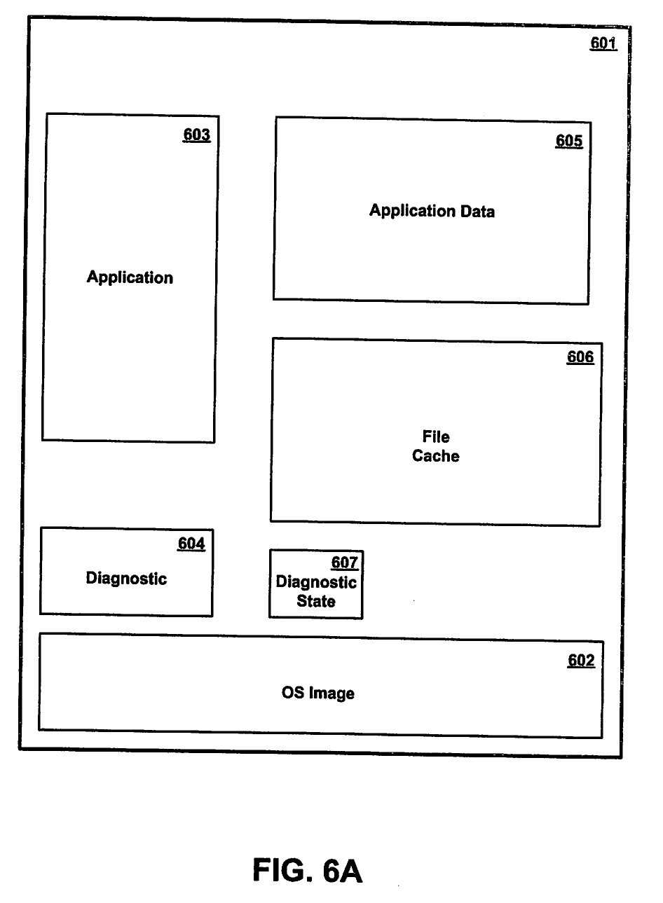

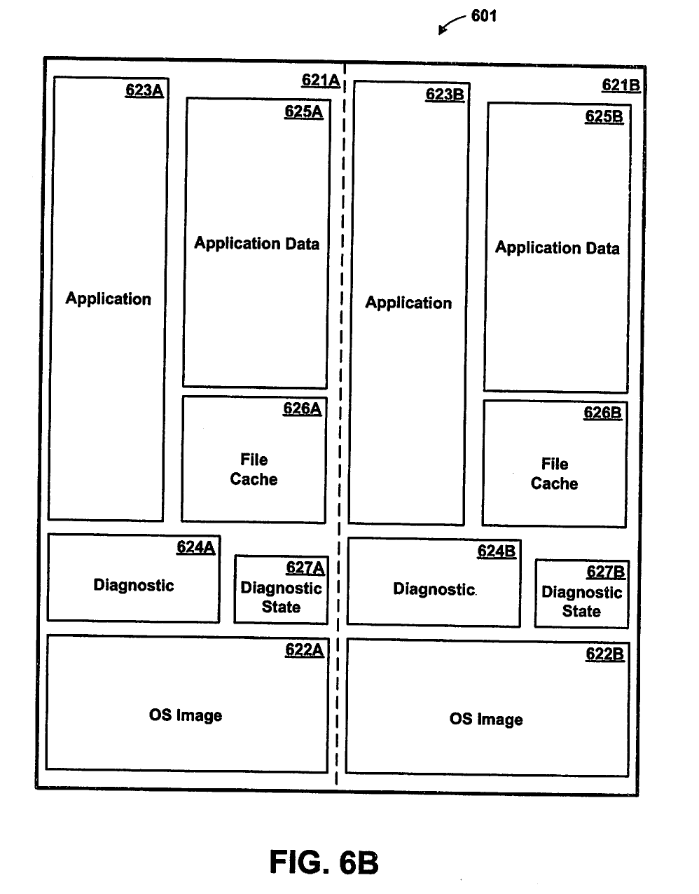

FIGS. 6A and 6B are high-level block diagrams of the major software components of memory in a compute node 112 of computer system 100 configured in different operating modes in accordance with the preferred embodiment, FIG. 63A representing a compute node configured according to a coprocessor operating mode, and FIG. 6B representing a compute node configured according to a virtual node operating mode.

Each compute node 112 comprises a single addressable nodal memory 601, which is physically embodied as on-chip memory 505 and external memory 502. From a hardware standpoint, all of nodal memory is accessible by either processor core 503A, 503B. Each compute node can operate in either coprocessor mode or virtual node mode, independently of the operating modes of the other compute nodes. When operating in coprocessor mode, the processor cores of a compute node do not execute independent threads. Processor Core A 503A acts as a primary processor for executing the user application sub-process assigned to its node, while Processor Core B 503B acts as a secondary processor which handles certain operations (particularly communications related operations) on behalf of the primary processor. When operating in virtual node mode, the physical node is logically divided into two “virtual nodes” capable of independent thread execution. I.e., in virtual node mode, nodal memory is partitioned between the two processors, and each processor core executes its own user application sub-process independently and independently maintains process state in its own partition, although these sub-processes may be, and usually are, separate sub-processes of a common user application. Because each node effectively functions as two virtual nodes, the two processor cores of the virtual node constitute a fourth dimension of the logical three-dimensional lattice 201. I.e., to specify a particular virtual node (a particular processor core and its associated subdivision of local memory), it is necessary to specify an x, y and z coordinate of the node (three dimensions), plus a virtual node (either A or B) within the node (the fourth dimension).

Although system 100 is a general purpose computing machine, it is designed for maximum efficiency in applications which are compute intensive. If each node of system 100 generates considerable I/O traffic, the I/O resources will become a bottleneck to performance. In order to minimize I/O operations, the compute nodes are designed to operate with relatively little paging activity from storage. To accomplish this, each compute node contains its own complete copy of a simplified operating system (operating system image) in nodal memory 601, and a copy of the application code being executed by the processor core. Unlike conventional multi-tasking system, only one software user application sub-process is active at any given time. As a result, there is no need for a relatively large virtual memory space (or multiple virtual memory spaces) which is translated to the much smaller physical or real memory of the system's hardware.

As shown in FIG. 6A, when executing in coprocessor mode, the entire nodal memory 601 is available to the single software application being executed. The nodal memory contains an operating system image 602, an application code image 603, and user application data structures 605 as required. Some portion of nodal memory 601 may further be allocated as a file cache 606, i.e., a cache of data read from or to be written to an I/O file. In the preferred embodiment, nodal memory further contains an executable diagnostic module 604 performing at least one interruptible and resumable diagnostic function, and diagnostic state data 607 which records the state of diagnostic functions performed by diagnostic module 604.

Operating system image 602 contains a complete copy of a simplified-function operating system. Operating system image 602 includes certain state data for maintaining process state. Operating system image 602 is preferably reduced to the minimal number of functions required to support operation of the compute node. Operating system image 602 does not need, and preferably does not contain, certain of the functions normally contained in a multi-tasking operating system for a general purpose computer system. For example, a typical multi-tasking operating system may contain functions to support multi-tasking, different I/O devices, error diagnostics and recovery, etc. Multi-tasking support is unnecessary because a compute node supports only a single task at a given time; many I/O functions are not required because they are handled by the I/O nodes 111; many error diagnostic and recovery functions are not required because that is handled by control subsystem 102 or front-end nodes 103, and so forth. In the preferred embodiment, operating system image 602 contains a simplified version of the Linux operating system, it being understood that other operating systems may be used, and further understood that it is not necessary that all nodes employ the same operating system.

Application code image 603 is preferably a copy of the application code being executed by compute node 112. Application code image may contain a complete copy of a computer program which is being executed by system 100, but where the program is very large and complex, it may be subdivided into portions which are executed by different respective compute nodes.

Diagnostic module 604 is a copy of executable code for performing at least one diagnostic function. Preferably, the diagnostic function is interruptible and resumable, although these qualities are not strictly necessary. I.e., preferably, the diagnostic function is one that can be interrupted at any point in its progress, and can be later resumed at the point it previously left off. Diagnostic module could perform a battery of functions, which individually may be interruptible, or alternatively, are not individually interruptible, but can be interrupted at the completion of each individual function. Although called a “diagnostic module”, it would alternatively be possible to perform any of various functions related to system maintenance, such as collection of performance statistics, metering of system usage, and so forth. In the preferred embodiment, diagnostic module contains at least one function for performing a memory check, i.e., a function which sequentially tests locations in memory to verify functionality. Although represented as a separate entity, diagnostic module 604 could be a part of operating system image 602.

Referring to FIG. 6B, when executing in virtual node mode, nodal memory 601 is subdivided into a respective separate, discrete memory subdivision 621A, 621B (herein generically referred to as feature 621) for each processor core. These memory subdivisions are represented in FIG. 6B as contiguous regions of nodal memory, although it should be understood that they need not be contiguous.

In virtual node mode each subdivision 621 contains its own copy of operating system image 622A, 622B (herein generically referred to as feature 622). Like operating system image 602 used in coprocessor mode, operating system image 622 is an image of a reduced-function operating system, preferably a reduced-function Linux operating system. In the preferred embodiment all compute nodes use the same reduced function operating system, and the instruction code contained in the various operating system images 602, 622 is identical (although state data embedded in the image may, of course, vary). However, since system hardware is general and each compute node executes its instructions independently, it would conceivably be possible to employ different operating systems in different compute nodes, and even to employ different operating systems for different processor cores in the same compute node when operating in virtual node mode.

In virtual node mode, each subdivision 621 further contains its own copy of a respective application code image 623A, 623B (herein referred to generically as feature 623) as well as any application data structures 625A, 625B, and file caches 626A, 626B required to support the user application sub-process being executed by the associated processor core. Since each node executes independently, and in virtual node mode, each co-processor has its own nodal memory subdivision 621 maintaining an independent state, application code images 623 within the same node may be different, not only in state data but in the executable code contained therein. Typically, in a massively parallel system, blocks of compute nodes are assigned to work on different user applications or different portions of a user application, and within a block all the compute nodes might be executing sub-processes which use a common application code instruction sequence. However, it is possible for every compute node 111 in system 100 to be executing the same instruction sequence, or for every compute node to be executing a different respective sequence (i.e. using a different respective application code image).

In virtual node mode, each subdivision 621 further contains its own copy of a respective diagnostic module 624 and diagnostic state data 627. Each copy of diagnostic module 624 may be identical, or they may be different, each virtual mode being allocated a different respective diagnostic function. In the preferred embodiment, in which diagnostic modules 624 include a memory check function, each diagnostic module 624A, 624B includes the memory check function, and each virtual node checks memory only in its own subdivision 621.

In either coprocessor or virtual node operating mode, a processor core only addresses memory locations in local nodal memory 601, and has no capability to address memory locations in other nodes. When operating in coprocessor mode, the entire nodal memory 601 is accessible by each processor core 503 in the compute node. When operating in virtual node mode, a single compute node acts as two “virtual” nodes. This means that a processor core 503 may only access memory locations in its own discrete memory subdivision 621. In the representation of FIG. 6B, processor core 503A can access only memory locations in subdivision 621A, and processor core 503B can access only memory locations in subdivision 621B.

While a system having certain types of nodes and certain inter-nodal communications structures is shown in FIGS. 1-4, and a typical node having two processor cores and various other structures and software components is shown in FIGS. 5, 6A and 6B, it should be understood that FIGS. 1-5, 6A and 6B are intended only as a simplified example of one possible configuration of a massively parallel system for illustrative purposes, that the number and types of possible devices in such a configuration may vary, and that the system often includes additional devices not shown. In particular, the number of dimensions in a logical matrix or lattice for inter-nodal communication might vary; a system might have other and/or additional communication paths; and a system might be designed having only a single processor for each node, with a number of processors greater than two, and/or without any capability to switch between a coprocessor mode and a virtual node mode. While various system components have been described and shown at a high level, it should be understood that a typical computer system contains many other components not shown, which are not essential to an understanding of the present invention. Furthermore, although a certain number and type of entities are shown in the simplified representations of FIGS. 1-5, 6A and 6B, it will be understood that the actual number of such entities may vary and in particular, that in a complex computer system environment, the number and complexity of such entities is typically much larger.

Typically, computer system 100 is used to execute large applications in parallel on multiple nodes, meaning that each of multiple compute nodes 112 executes a respective portion (sub-process) of the application, having its own local one or more threads and maintaining its own local application state data. It is possible to allocate all of the compute nodes 112 to a single application, or to allocate some subset of the compute nodes to a single application, and thus execute multiple applications concurrently in separate subsets.

When an application is executed on multiple nodes in parallel, and data is exchanged among the various nodes, there is generally a need to synchronize the progress of the various sub-processes executing in different nodes. System 100 supports two separate synchronization mechanisms, either of which may be used. It may additionally be possible to synchronize sub-processes by appropriate programming of messages passed between the sub-processes, or using some other mechanism, although system 100 does not provide mechanism.

Barrier network 116 provides a form of explicit synchronization. Barrier network can be used to propagate a logical AND of a respective sub-process progress state signal from each compute node 112. I.e., each node, upon reaching a pre-determined synchronization point in its respective sub-process, outputs an appropriate logic progress state signal to the barrier network. These signals propagate up the barrier network tree. When all nodes have output the logic signal, indicating that all nodes have reached the synchronization point, the barrier network output changes to signal that the synchronization point has been reached by all nodes, and this output is propagated down the tree to all nodes. Upon receipt of the synchronization signal, the nodes then reset their progress state signal outputs, and continue executing their respective sub-processes until the next synchronization point. If only a subset of nodes is required to reach the synchronization point, the output of the nodes not in the subset can be set to the appropriate logic level initially, so that they do not affect the barrier network's synchronization.

An alternative form of synchronization can be provided by collective network 401, and is referred to herein as implicit synchronization. As explained above, the collective network can be used to perform certain reduction operations, in which data input from each node is used to generate a composite result. This data migrates up the collective network tree, being combined with data from other nodes at each level of the tree, until it reaches the root, at which point the collective result is produced. The collective result can then be propagated down the tree. If multiple sub-processes are required to provide data for a reduction operation and receive a result, the sub-processes will necessarily wait after providing the data until the result is propagated back. The reduction operation therefore becomes an implicit synchronization point, since the collective result of the reduction operation can not be produced until all nodes (or all nodes of a defined subset) have provided their inputs.

In accordance with the preferred embodiment of the present invention, when a node executing a sub-process of a larger application reaches a synchronization point (which may be a synchronized explicitly using barrier network 106, or implicitly using a reduction operation in collective network 401, or otherwise) and at least one other node has not yet reached the synchronization point, so that the node must wait for the other node to catch up, the node activates an interruptible and resumable diagnostic function while waiting for all other nodes to reach the synchronization point. The node continues to execute the diagnostic function until all nodes reach the synchronization point (or until the occurrence of some other overriding event, such as completion of the diagnostic function, system-wide interrupt, etc.). Upon all nodes reaching the synchronization point, the diagnostic function is interrupted, and the progress state of the diagnostic function is saved in diagnostic state data 607 or 627. The application sub-process then resumes.

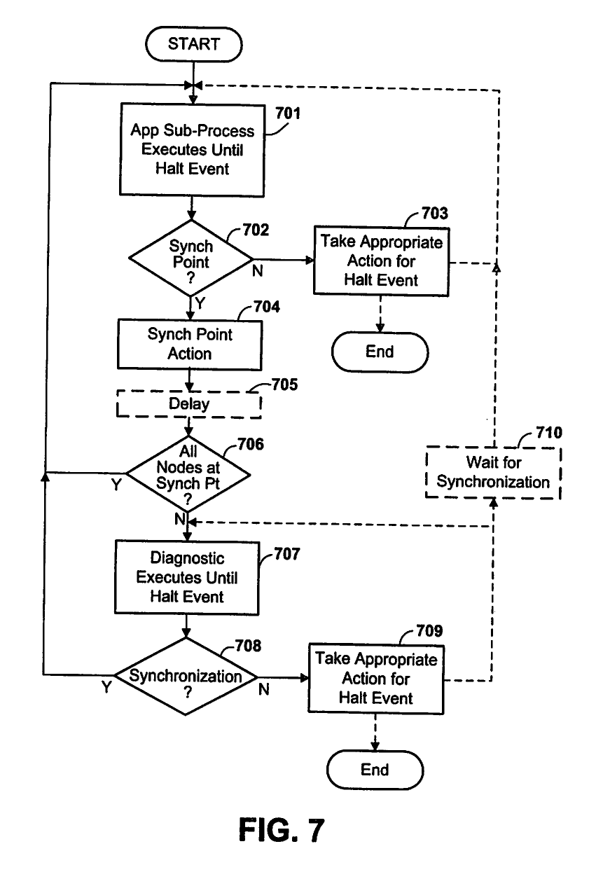

FIG. 7 is a high level flow diagram of the actions taken within a single subject compute node 112 to execute a sub-process of an application and perform diagnostic functions while idling at synchronization points, according to the preferred embodiment. As shown in FIG. 7, an application sub-process assigned for execution in the subject node executes in the subject node (i.e., on the subject node's processor or processors 503) until a halt event occurs, i.e. until the occurrence of some event causing a halt in execution (step 701).

If the halt event is something other than a synchronization point, the ‘N’ branch is taken from step 702, and appropriate action is taken responsive to the halt event (step 703). For example, a halt event could be completion of the application sub-process, in which case the node might simply end execution. A halt event might alternatively be some externally generated interrupt. After taking appropriate action, the node might resume execution of the application sub-process at step 701, or might end execution, depending on the nature of the halt event.

If the halt event is a synchronization point, the ‘Y’ branch is taken from step 702. A “synchronization point”, as used herein, is any event requiring a process in one or more nodes to wait while a process in one or more other nodes reaches a progress point, and could be an explicit synchronization using barrier network 116, an implicit synchronization resulting from a reduction operation performed with collective network 401, or some other mechanism which is used to achieve synchronization. In this case, the subject node takes any required synchronization action (step 704). For example, in the case of an explicit synchronization using barrier network 116, the subject node transmits a signal on the barrier network indicating that it has reached its synchronization point. In the case of a reduction operation, the subject node would provide its data to the collective network.

The subject node may optionally delay a brief period, represented as step 705, before proceeding to allow for transmission latencies in the barrier network, collective network, or other mechanism. If the appropriate mechanism indicates that all nodes have reached synchronization, the ‘Y’ branch is taken from step 706, and the subject node resumes execution of its application sub-process, until the next halt event (step 701). If synchronization has not been reached, the ‘N’ branch is taken from step 706, and the subject node initiates or resumes execution of a diagnostic function. This diagnostic function executes until it encounters some halt event (step 707). The state of the diagnostic function is maintained in diagnostic state data 607, 627; preferably, the diagnostic function is resumable at the point at which it left off using this state data.

Among the events which may cause the diagnostic function to halt is the occurrence of synchronization. Preferably, a hardware interrupt signal is generated when all applicable nodes have reached the synchronization point, although synchronization could be detected by other means, such as periodic polling. If the halt event is a synchronization indication, the ‘Y’ branch is taken from step 708, and the subject node resumes execution of its application sub-process at step 701.

If the halt of the diagnostic function was caused by something other than a synchronization indication (the ‘N’ branch from step 708), then the node takes action appropriate to the type of halt event (step 709). For example, the halt may have occurred because the diagnostic function detected an abnormality. In this case, appropriate action might include logging the abnormality, generating an error message, or the like. The halt may alternatively have occurred because the diagnostic function completed, or because some external overriding interrupt caused operation to be aborted, or for some other cause. Whatever the cause, after taking appropriate action, the node might: (a) resume execution of the diagnostic function at step 707; or (b) wait for a synchronization indication at step 710 without resuming execution of diagnostics (and, upon synchronization, resume execution of the application sub-process at step 701); or (c) terminate execution.

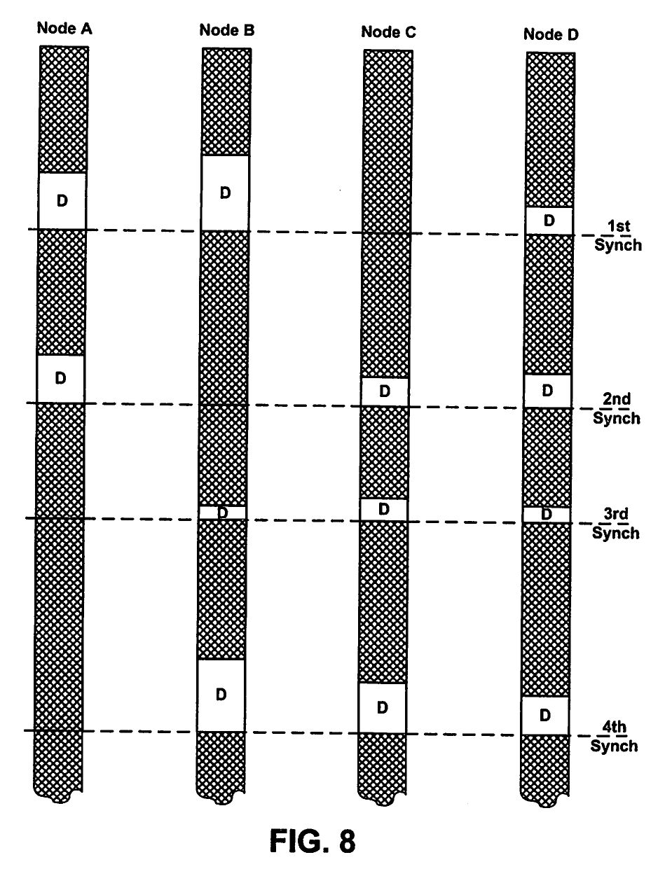

It will be recognized that the amount of processor resource (time) devoted in each of multiple nodes to a diagnostic function is not necessarily the same. For example, one node may reach a synchronization point early and be able to devote considerable processor resource to the diagnostic function, while the last node to reach synchronization is unable to execute the diagnostic function at all. However, if, as in the preferred embodiment, the diagnostic function is interruptible and resumable, then it may be continued at one or more subsequent synchronization points. Although there is no guarantee that, in any particular node and at any particular synchronization point, there will be time to execute the diagnostic function, it is expected that over multiple synchronization points, this imbalance will be more or less randomly distributed and each node will be able to provide some processor resource for executing diagnostics, without delaying the progress of the application. This phenomenon is illustrated in FIG. 8.

Referring to FIG. 8, a timeline showing progress of four sub-processes of a common application in four respective nodes A, B, C and D is shown. In this timeline, time increases moving downward in the figure. In each node, a shaded area represents time during which a corresponding sub-process of the application is executing, and an unshaded area designated “D” indicates a time in which a diagnostic function is executing.

In nodes A, B, and D, the corresponding sub-process executes until a first synchronization point is reached, the synchronization being reached at different respective times. In each of these nodes, a corresponding diagnostic function “D” is initiated upon reaching the synchronization point, the diagnostic function continuing until the last node (node C) reaches the synchronization point. Node C's reaching the synchronization point causes a synchronization signal to be propagated to the other nodes, and which point the diagnostic functions in nodes A, B and D are interrupted. Execution of the corresponding sub-processes then resumes. It will be observed that no diagnostic function is executed in node C at the first synchronization point, since that is the last node to reach synchronization.

At the second synchronization point, nodes A, C and D reach the synchronization point, and begin or resume the diagnostic function, while waiting for node B to reach synchronization. Upon node B's reaching the synchronization point, the diagnostic functions in nodes A, C and D are interrupted, and the sub-processes of the application resume. As in the case of the first synchronization point, there is no diagnostic function executed in node B at the second synchronization point, since that is the last node to reach synchronization.

This process continues similarly through the third and fourth synchronization points. It will be observed that, after the fourth synchronization point, each node has had an opportunity to execute its respective diagnostic function at at least some of the synchronization points, although not necessarily at every synchronization point. Over a large number of nodes and synchronization points, it is expected that each node will have sufficient opportunity to perform diagnostics.

In the preferred embodiment, a diagnostic function, which is specifically a memory check function, is executed during idle times while waiting for a synchronization point to be reached. However, any of various alternative diagnostic or other system maintenance functions could be executed, and it would be possible to execute a battery of multiple diagnostic and/or other system maintenance functions. For example, one form of system maintenance operation which could alternatively be performed is the updating of performance counters which accumulate statistics relating to the performance of the system or selective components thereof. Another form of system maintenance operation is the updating of accounting activity/counters. While it is preferred that any such system maintenance operation be interruptible and resumable at the point of interruption, this is not necessarily required, particularly for activities of relatively short duration.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of computer-readable signal-bearing media used to actually carry out the distribution. Examples of signal-bearing media include, but are not limited to, volatile and non-volatile memory devices, floppy disks, hard-disk drives, CD-ROM's, DVD's, magnetic tape, and so forth. Furthermore, the invention applies to any form of signal-bearing media regardless of whether data is exchanged from one form of signal-bearing media to another over a transmission network. Examples of signal-bearing media are illustrated in FIG. 1 as memory 122 and storage devices 109A, 109B, 125, and in FIG. 5 as memory 505.

Although a specific embodiment of the invention has been disclosed along with certain alternatives, it will be recognized by those skilled in the art that additional variations in form and detail may be made within the scope of the following claims:

What is claimed is:

1. A method for operating a parallel computer system, comprising the steps of:
executing each of a plurality of sub-processes of a common process in parallel in a respective component of said parallel computer system;
halting a first sub-process of said plurality of sub-processes at a synchronization point of said common process while waiting for at least one other sub-process of said plurality of sub-processes to reach said synchronization point, said first sub-process executing in a first component of said parallel computer system; and
automatically executing a system maintenance operation in said first component while said first sub-process is halted while waiting for at least one other sub-process of said plurality of sub-processes to reach said synchronization point.

2. The method of claim 1, wherein each said component comprises a respective node of a plurality of nodes of said parallel computer system, each node having at least one processor for executing instructions and a nodal memory addressable by said at least one processor.

3. The method of claim 2, wherein each said node contains a respective copy of instructions for executing said system maintenance operation in the at least one processor of the node, said respective copy of instructions for executing said system maintenance operation being stored in the nodal memory of the respective node.

4. The method of claim 1, wherein said system maintenance operation is a diagnostic operation for diagnosing at least one condition of said parallel computer system.

5. The method of claim 4, wherein said diagnostic operation is a memory check function which successively checks different locations of memory.

6. The method of clam 1, wherein said system maintenance operation is interruptible and restartable at the point of interruption.

7. The method of claim 1, further comprising the steps of:
halting a respective subset of said plurality of sub-processes at each of a plurality of synchronization points of said common process while waiting for at least one respective sub-process of said plurality of sub-processes which is not a member of the respective subset to reach the respective synchronization point, each sub-process executing in a respective component of said parallel computer system; and
automatically executing a respective system maintenance operation in each component corresponding to a sub-process of a said subset of said plurality of sub-processes while said sub-processes of the respective subset are halted while waiting for the at least one respective sub-process of said plurality of processes which is not a member of the respective subset to reach the respective synchronization point.

8. The method of claim 7, wherein at least some of said subsets of said plurality of sub-processes are different, and wherein each said sub-process of said plurality of sub-processes is a member of at least one said subset.

9. A program product for operating a parallel computer system, said parallel computer system comprising a plurality of parallel components, each component for executing a respective sub-process of a common process in parallel, the program product comprising:
a plurality of computer executable instructions recorded on signal-bearing media, wherein said instructions cause the computer system to perform the steps of:
halting a first sub-process of said plurality of sub-processes at a synchronization point of said common process while waiting for at least one other sub-process of said plurality of sub-processes to reach said synchronization point, said first sub-process executing in a first component of said parallel computer system; and
automatically executing a system maintenance operation in said first component while said first sub-process is halted while waiting for at least one other sub-process of said plurality of sub-processes to reach said synchronization point.

10. The program product of claim 9, wherein each said component comprises a respective node of a plurality of nodes of said parallel computer system, each node having at least one processor for executing instructions and a nodal memory addressable by said at least one processor.

11. The program product of claim 10, wherein each said node contains a respective copy of instructions for executing said system maintenance operation in the at least one processor of the node, said respective copy of instructions for executing said system maintenance operation being stored in the nodal memory of the respective node.

12. The program product of claim 9, wherein said system maintenance operation is a diagnostic operation for diagnosing at least one condition of said parallel computer system.

13. The program product of claim 12, wherein said diagnostic operation is a memory check function which successively checks different locations of memory.

14. The program product of claim 9, wherein said system maintenance operation is interruptible and restartable at the point of interruption.

15. The program product of claim 9, wherein said instructions further cause the computer system to perform the steps of:
halting a respective subset of said plurality of sub-processes at each of a plurality of synchronization points of said common process while waiting for at least one respective sub-process of said plurality of sub-processes which is not a member of the respective subset to reach the respective synchronization point, each sub-process executing in a respective component of said parallel computer system; and
automatically executing a respective system maintenance operation in each component corresponding to a sub-process of a said subset of said plurality of sub-processes while said sub-processes of the respective subset are halted while waiting for the at least one respective sub-process of said plurality of processes which is not a member of the respective subset to reach the respective synchronization point.

16. The program product of claim 15, wherein at least some of said subsets of said plurality of sub-processes are different, and wherein each said sub-process of said plurality of sub-processes is a member of at least one said subset.

17. A parallel computer system, comprising:
a plurality of nodes, each node having at least one processor for executing a respective application sub-process of a common process being executed in parallel and a memory accessible by the at least one processor;
a respective system maintenance function executable in each of a plurality of said nodes; and
an idle utilization mechanism executable in each of a plurality of said nodes, each said idle utilization mechanism determining when a respective sub-process executing in its respective node is halted at a synchronization point of said common process while waiting for at least one other sub-process of said common process to reach said synchronization point, and responsive to such a determination, automatically executing a system maintenance operation while the respective sub-process is halted while waiting for at least one other sub-process of said common process to reach said synchronization point.

18. The parallel computer system of claim 17, further comprising a barrier network providing at least one synchronization signal to each of said plurality of nodes, said synchronization signal notifying each of said plurality of nodes when all sub-processes of said common process have reached said synchronization point.

19. The parallel computer system of claim 18, further comprising at least one network for communicating process data among said plurality of nodes separate from said barrier network.

20. The parallel computer system 17, wherein said system maintenance operation is a diagnostic operation for diagnosing at least one condition of said parallel computer system.
